(19) United States
(12) Patent Application Publication
(10) Pub. No.: US 2004/0112968 A1
(43) Pub. Date: Jun. 17, 2004

(54) Nonstandard-sized transaction card

(76) Inventors: Lisa Ann Morrill Webb, Darien, CT (US); Ellen Lasch, New York, NY (US); Priscilla Gandel, Long Branch, NJ (US)

Correspondence Address: Stephen T. Scherrer, McDERMOTT, WILL & EMERY, 227 West Monroe Street, Chicago, IL, 60606-5096, US

(21) Appl. No.: 10/601,220

(22) Filed: Jun. 20, 2003

Related U.S. Application Data
(60) Provisional application No. 60/432,726, filed on Dec. 11, 2002.

(51) Int. Cl. G06K 19/06

(52) U.S. Cl. 235/493

(57) ABSTRACT

A transaction card is provided having at least one dimension that is different from a standard-sized transaction card. In addition, a transaction card is provided having a magnetic stripe having a length measurement different from standard-sized transaction cards. Moreover, a transaction card is provided having one or more holes or apertures therein for holding a keychain, or other device for attaching the transaction card to another item, such as a set of keys, a wallet, or other item.

### CROSS REFERENCE TO RELATED APPLICATIONS

The present application claims the benefit of U.S. Provisional Application serial No. 60/432,726, filed Dec. 11, 2002.

### FIELD OF THE INVENTION

The present invention relates to a transaction card having one or more of a magnetic stripe, holographic security device, signature panel, picture of the owner of the transaction card, embedded microchip, radio frequency devices or any other item or element that may be-useful for the transaction card, and having at least one dimension that is different from a conventionally-sized or standard-sized transaction card.

### BACKGROUND OF THE INVENTION

It is generally known to provide transaction cards for providing a means for purchasing goods or services without the use of paper money or coinage. Specifically, transaction cards may represent credit, whereby a user of the transaction card may present the card in lieu of the paper money or coinage. Alternatively, transaction cards may be debit cards, whereby electronic money, such as money stored in an account, is removed from the account each time that the transaction card is used. In addition, transaction cards may have a certain amount of money, or other valuable commodity, recorded thereon, whereby a user of the transaction card may remove the money directly from the transaction card. For example, retail stores now offer cards that can be purchased for a certain amount of money. That amount, or any other amount, may be represented on the transaction card. When the transaction card is utilized, the amount represented on the card may be reduced until the transaction card represents that it cannot be utilized anymore, or that the card represents that it is not Worth any more money. Of course, other value besides currency may be represented on the transaction card, such as equivalent goods or services.

Transaction cards typically have a magnetic stripe provided, or some other means, for storing information relating to the transaction card, such as, a security code, and information relating to an account or an amount of money that the transaction card may represent. For example, if the transaction card is a debit card, the information contained on the magnetic stripe may relate to an account whereby use of the credit card may alert the account to release funds for the purchase of goods or services. Of course, the magnetic stripe or other means may further contain any other information to allow the transaction card to be utilized. The transaction card is typically fed into or through a reader that reads the information contained on the magnetic stripe to extract the information as needed when the transaction card is being used. Alternatively, the transaction card may have means for being read by a card reader or sensor when the transaction card is brought within a certain distance of the reader or sensor, such as, for example, a wireless card reader that reads a microchip that may be embedded within or on layers of the transaction card.

The transaction card may further contain other features that allow for the secure and efficient use of the transaction card, such as holographic security devices, signature panels, photographs or other representative images of the owner of the transaction card, embedded microchips, radio frequency devices or any other item or element that may be useful for use and/or security of the transaction card.

Transaction cards are typically sized according to standards set by the International Organization for Standardization (ISO). This means that typical transaction cards being utilized are of the same size and dimensions, typically approximately 2 1/4 inches wide by 3 3/8 inches long, in a generally rectangular configuration. However, a transaction card having dimensions according to this standard typically is too big in either one or both dimensions to be stored in a convenient way except loose in a pocket, wallet or purse, or contained within a slot in a wallet or purse allowing the snug fit of the transaction card. Transaction cards are, therefore, highly susceptible to being lost or stolen. Other shapes and/or sizes would allow the transaction cards to be conveniently attached to, secured with, or otherwise stored with other items, such as key chains, for example.

A need exists, therefore, for a transaction card having the capability to be conveniently stored with other items or in smaller areas than are currently allowed. For example, a need exists for a transaction card that may be clipped or otherwise attached to a keychain, or some other means for securing the transaction card to another item, yet is small enough to remain inconspicuous and compact, but handy. Further, a need exists for a transaction card having the above-noted advantages and further that maintains the information or other features typically disposed on or within a transaction card.

### SUMMARY

The embodiments described herein relate to a transaction card having one or more of a magnetic stripe, holographic security device, signature panel, photographs or other representative images of the owner of the transaction card, embedded microchips, or any other items or elements that may be useful for the use and/or security of the transaction card, and in which the transaction card has at least one dimension that is different from a conventionally-sized transaction card. Moreover, the present invention relates to a transaction card having one or more holes or apertures therein for holding a keychain, or other device for attaching the transaction card to another item, such as a set of keys, a wallet, or other item.

A transaction card is provided that is sized so as to be highly compact so that the transaction card may be stored in small areas. Further, a transaction card is provided that may be attached to another item via a securing means, such as a ring or chain.

In addition, a transaction card is provided that can be attached to a keychain, yet still remain small and compact. Therefore, the transaction card may be small enough to be inconspicuous and be secured to another item thereby minimizing the chance that the transaction card will be misplaced, lost or stolen.

Further, a transaction card is provided that comprises other features typically found on or within a transaction card, such as security devices, embedded microchips, or magnetic stripes having information stored thereon or the like. Still further, a transaction card is provided having a magnetic stripe that is shorter than standard-sized magnetic stripes, thereby allowing for smaller-sized transaction cards, or transaction cards having larger areas on the faces of the transaction cards for other features, such as security devices, embedded microchips, photographs or other representative images, printing, radio frequency devices or the like. In addition, a transaction card is provided having a magnetic stripe that is longer that standard-sized magnetic stripes, thereby allowing for larger-sized transaction cards, or transaction cards with the ability to store more information on the magnetic stripes than standard transaction cards with standard-sized magnetic stripes.

Additional features and advantages of the present invention are described in, and will be apparent from, the detailed description of the presently preferred embodiments and from the drawings.

### BRIEF DESCRIPTION OF THE DRAWINGS

FIG. 1 illustrates a transaction card in an embodiment described herein.

FIGS. 2A and 2B illustrate transaction cards in alternate embodiments described herein.

FIGS. 3A and 3B illustrate transaction cards in still further embodiments described herein.

FIG. 4 illustrates a transaction card in yet another embodiment described herein.

FIG. 5 illustrates a transaction card in still another embodiment described herein

### DETAILED DESCRIPTION OF THE PRESENTLY PREFERRED EMBODIMENTS

Referring now to FIG. 1, a first embodiment is illustrated. FIG. 1 illustrates a rear view of a transaction card 10, shown generically as merely having a magnetic stripe 12 on the back side 14 of the card. Other features not shown, however, may be provided on the front or back side of the transaction card, such as, for example, a signature panel, an embedded microchip, a holographic image, radio frequency devices or the like. These features may allow the transaction card to function more easily, efficiently, and/or more securely.

Of course, the transaction card 10 typically comprises a plurality of layers (not shown) to form the rigid card. For example, transaction cards typically include inner layers of a polymeric material to provide the transaction card with thickness and bulk. In addition, outer layers are typically provided comprising a polymeric material that protects the inner layers of the transaction card. In addition, the polymeric material of the outer layers may provide rigidity and further may add to the thickness of the transaction card.

The transaction card 10, and the other transaction cards described herein, may be made from any generally known material typically used for transaction cards, such as, for example, polyvinylchloride (PVC) and polypropylene (PP). Typically, transaction cards such as the ones described herein have multiple layers of polymeric materials. For example, a typical card may have one or more internal layers of PVC or PP, and outer layers of polyethylene terephthlate (PET) for rigidity and strength. Other materials, such as thermoplastic polymeric materials, or other materials, such as paper or metal, may be utilized to form the transaction card 10.

In addition, transaction cards may be transparent, as described in U.S. patent application Ser. No. 10/092,681, filed Mar. 7, 2002, which is a continuation-in-part application of U.S. patent application Ser. No. 10/062,106, filed Jan. 31, 2001, which is a continuation-in-part application of U.S. patent application Ser. No. 09/653,837, filed Sep. 1, 2000 and further claims the benefit of U.S. Provisional Application No. 60/153,112, filed Sep. 7, 1999; U.S. Provisional Application No. 60/160,519, filed Oct. 20, 1999; U.S. Provisional Application No. 60/167,405, filed Nov. 24, 1999; U.S. Provisional Patent Application No. 60/171,689, filed Dec. 21, 1999 and U.S. patent application Ser. No. 09/652,899, entitled “Methods And Apparatus For Conducting Electronic Transactions” filed Aug. 31, 2000, each of which is expressly incorporated herein in its entirety. The transparent transaction card may contain a plurality of layers or an infrared-blocking ink to allow the transparent transaction cards to be recognized by a card reader.

The magnetic stripe 12 may contain a material for storing information that may be read by a magnetic reader. Typically, the magnetic stripe 12 stores a series of digits that the magnetic card reader can read to obtain information about the account that the transaction card is associated with, or otherwise to obtain information relating to the owner of the transaction card or the amount of money or other equivalent good or service represented by the transaction card 10. Therefore, the information contained on the magnetic stripe, 12 must be readable by a magnetic card reader. As shown, the magnetic stripe 12 is parallel to a side 18 of the transaction card 10. Alternatively, the magnetic stripe may be provided in parallel with one of the other sides 19 of the transaction card.

Provided in the transaction card 10 may be one or more aperture 16 that may be utilized to attach the transaction card 10 to a securing means, such as a key ring. Of course, any other securing means, such as a chain or string, for example, may be utilized and the invention should not be limited as herein described. The securing means can be provided in any of the apertures described herein as needed.

The transaction card 10 shown has a width (W) and a length (L). In the embodiment described herein with reference to FIG. 1, the transaction card has a width W of less than approximately 1 inch and a length L of also less than approximately 1 inch. For example, as shown in FIG. 1, the transaction card 10 is generally square and the width W could be approximately 3/4 inch and the length L could also be approximately 3/4 inch.

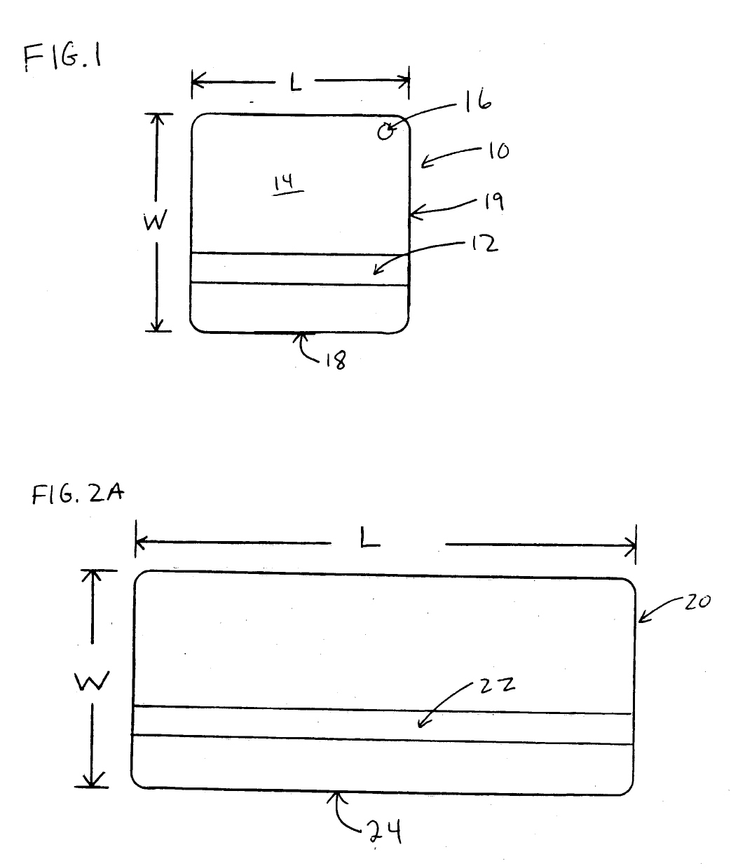

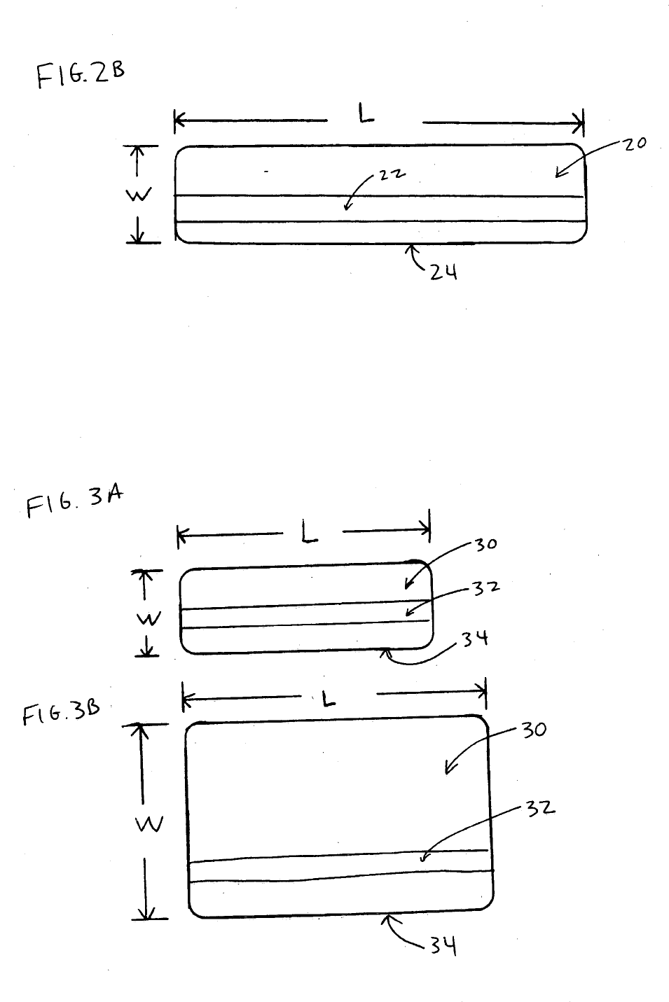

FIGS. 2A and 2B illustrate alternate embodiments of the present invention of a transaction card 20 having a magnetic stripe 22 that is parallel to a side 24 of the transaction card 20. The transaction card 20 may be made from the same or similar materials as the transaction card 10 described above with reference to FIG. 1.

The transaction card 20 shown has a width (W) and a length (L). In this particular embodiment, the transaction card 20 has a length L of greater than 3 inches, and more preferably of greater than approximately 3⅜ inches. For example, as shown in FIG. 2A, the transaction card 20 may have a width W of approximately 2 inches and a length L of approximately 4 inches. Alternatively, as shown in FIG. 2B, the width could be approximately 1 inch and the length L could be approximately 3⅞ inches. Therefore, the transaction card 20 may be longer than a standard transaction card, but narrower than a standard transaction card. This may allow the transaction card 20 to be kept or stored in locations where the widthwise dimension limits the storage capability of the transaction card 20.

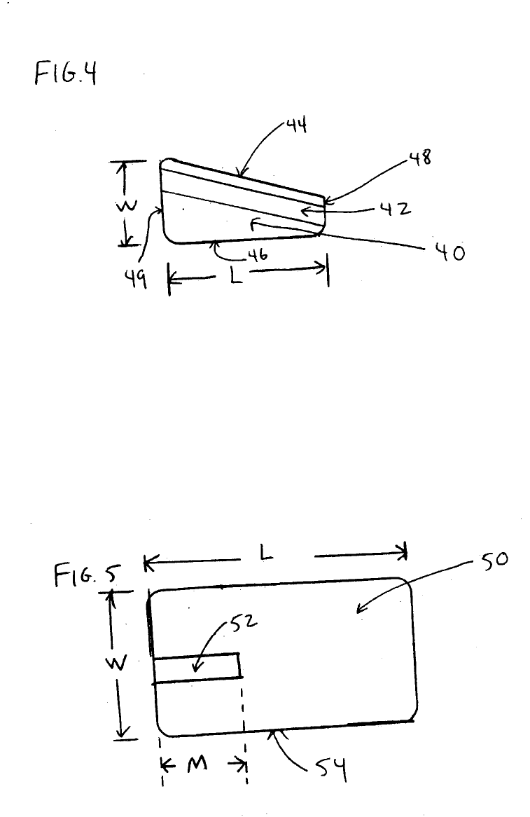

FIGS. 3A and 3B illustrate further alternate embodiments of the present invention of a transaction card 30 having a magnetic stripe 32 that is parallel to a side 34 of the transaction card 30. The transaction card 30 may be comprised of the same materials as described above with reference to the transaction card 10, as defined with reference to FIG. 1.

The transaction card 30 shown has a width (W) and a length (L). In the embodiment described herein with reference to FIGS. 3A and 3B, the transaction card 30 has a length L of between approximately 1 inch and approximately 3 inches and a width W of less than approximately 1 inch or greater than approximately 1⅞ inches. For example, as shown in FIG. 3A, the transaction card 30 may have a width W of approximately ¾ inch and a length L of approximately 2¼ inches. Alternatively, as shown in FIG. 3B, the width W could be approximately 2⅛ inches and the length L could be approximately 3 inches.

FIG. 4 illustrates an alternate embodiment of a transaction card 40 having a magnetic stripe 42 that is parallel to a side 44 of the transaction card 40. Alternately, the magnetic stripe may be parallel to one of the other sides 46, 48 or 49. The transaction card 40 may be comprised of the same or similar materials as that of the transaction card 10, described above with reference to FIG. 1. In this particular embodiment, the transaction card 40 has at least one set of opposing sides 44 and 46, or 48 and 49 which are not parallel.

The transaction card 40 shown has a width (W) and a length (L). The card 40 has a length L of between approximately 1 inch and approximately 1⅞ inches or a length L of greater than approximately 3 inches, and more preferably of greater than approximately 3⅜ inches. In addition, the width W is less than approximately 1 inch or greater than approximately 1⅞ inches. For example, as shown in FIG. 4, the transaction card 40 may have a width W of approximately ¾ inch and a length L of approximately 1½ inches. Alternatively, the width W could be approximately 2 inches and the length L could be approximately 3½ inches.

FIG. 5 illustrates an alternate embodiment of a transaction card 50 having a magnetic stripe 52 that is parallel to a side 54 of the transaction card 50. The transaction card 50 may comprise the same or similar material as that described above with reference to the transaction card 10, as noted above of the same or similar construction to the transaction card 10 described above.

The transaction card 50 may have any length L or width W, so long as the card 50 has a magnetic stripe 52 of length M, which is less than approximately 1 inch. Alternatively, the transaction card 50 may have any length L or width W, so long as the length M of the magnetic stripe 52 is greater than approximately 3 inches long and preferably greater than approximately 3 3/8 inches long.

The present invention has been described above with reference to exemplary embodiments. However, those skilled in the art having read this disclosure will recognize that changes and modifications may be made to the exemplary embodiments without departing from the scope of the present invention.

We claim:

1. A nonstandard-sized transaction card comprising a storage means for storing information wherein the nonstandard-sized transaction card comprises a length measurement and a width measurement, wherein both the length and width measurements are each less than about 1 inch.

2. The nonstandard-sized transaction card of claim 1 wherein the storage means is a magnetic stripe.

3. The nonstandard-sized transaction card of claim 2 wherein the magnetic stripe is parallel to an edge of the nonstandard-sized transaction card.

4. The nonstandard-sized transaction card of claim 1 further comprising an aperture disposed through the transaction card.

5. A nonstandard-sized transaction card comprising a storage means for storing information wherein the nonstandard-sized transaction card comprises a length measurement and a width measurement wherein the length measurement is greater than about 3 inches.

6. The nonstandard-sized transaction card of claim 5 wherein the storage means is a magnetic stripe.

7. The nonstandard-sized transaction card of claim 6 wherein the magnetic stripe is parallel to an edge of the nonstandard-sized transaction card.

8. The nonstandard-sized transaction card of claim 5 further comprising an aperture disposed through the transaction card.

9. A nonstandard-sized transaction card comprising a storage means for storing information, wherein the nonstandard-sized transaction card comprises a length measurement and a width measurement wherein the length measurement is between about 1 inch and about 3 inches, and further wherein the width measurement comprises a range selected from the group consisting of less than about 1 inch and greater than about 1 7/8 inches.

10. The nonstandard-sized transaction card of claim 9 wherein the storage means is a magnetic stripe.

11. The nonstandard-sized transaction card of claim 10 wherein the magnetic stripe is parallel to an edge of said nonstandard-sized transaction card.

12. The nonstandard-sized transaction card of claim 9 further comprising an aperture disposed through the transaction card.

13. A nonstandard-sized transaction card having at least one set of opposing sides that are not parallel to each other, wherein the nonstandard-sized transaction card comprises a length measurement comprising a range selected from the group consisting of between about 1 inch and about 1 7/8 inches and greater than about 3 inches, and further wherein the nonstandard-sized transaction card comprises a width measurement comprising a range selected from the group consisting of less than about 1 inch and greater than about 1 7/8 inches.

14. The nonstandard-sized transaction card of claim 13 further comprising a storage means for storing information relating to a transaction account.

15. The nonstandard-sized transactions card of claim 14 wherein the storage means comprises a magnetic stripe.

16. The nonstandard-sized transaction card of claim 15 wherein the magnetic stripe is disposed parallel to an edge of said transaction card.

17. The nonstandard-sized transaction card of claim 16 wherein the magnetic stripe is parallel to one of the sides of the set of opposing sides that are not parallel to each other.

18. The nonstandard-sized transaction card of claim 14 further comprising an aperture disposed through the transaction card.

19. A transaction card comprising a magnetic stripe, wherein the magnetic stripe has a measurement comprising a range selected from the group consisting of less than about 1 inch and greater than about 3 3/8 inches.

20. The transaction card of claim 19 wherein the transaction card is a nonstandard-sized transaction card.

21. The transaction card of claim 19 wherein the magnetic stripe is parallel to an edge of the transaction card.

22. The transaction card of claim 19 further comprising an aperture disposed through the transaction card.
